(19) United States
(12) Patent Application Publication
(10) Pub. No.: US 2008/0232596 A1
(43) Pub. Date: Sep. 25, 2008

(54) DATA PROCESSING APPARATUS AND PROGRAM

(76) Inventors: Shinichi MATSUKAWA, Tokyo (JP); Norikazu Hosaka, Fuchu-shi (JP); Masanori Noguchi, Tokyo (JP); Kazuhiro Kaiya, Tokyo (JP); Naoto Akimoto, Tama-shi (JP); Akihiro Kutsuzawa, Fuchu-shi (JP); Masahiro Taguchi, Fuchu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/052,218

(22) Filed: Mar. 20, 2008

(30) Foreign Application Priority Data
Mar. 23, 2007 (JP) 2007-077355

(51) Int. Cl. H04L 9/06; G06F 17/30

(52) U.S. Cl. 380/277; 707/200; 707/E17.005

(57) ABSTRACT

A data processing apparatus capable of updating and writing a plurality of distributed information items generated based on to-be-held secret information with respect to a data storage device in which access is not limited includes a secret distribution processing portion which generates a plurality of distributed information items updated this time according to secret information to be held this time based on a threshold value secret distribution method, and a distributed information management portion which selects recording positions of distributed information items updated this time to leave behind distributed information items of a number less than a threshold value among a plurality of distributed information items updated last time with respect to a plurality of distributed information items updated and stored in the data storage device and writes distributed information items updated this time to the data storage device based on the selected recording positions.

### CROSS-REFERENCE TO RELATED APPLICATIONS

This application is based upon and claims the benefit of priority from prior Japanese Patent Application No. 2007-077355, filed Mar. 23, 2007, the entire contents of which are incorporated herein by reference.

### BACKGROUND OF THE INVENTION

1. Field of the Invention

This invention relates to a data processing apparatus and a program used to write distributed data to a storage medium such as a hard disk drive (HDD) in an open environment in which access is not limited.

2. Description of the Related Art

Generally, processes for distributing contents such as music data and video data via a communication network such as ROM media and Internet are widely performed. In the contents distribution field, it is proposed to provide a system which distributes a bundle of decrypting keys having a plurality of decrypting keys capable of individually decrypting the respective encrypted contents when a plurality of encrypted contents are distributed (for example, refer to Jpn. Pat. Appln. KOKAI Publication No. 2006-254204).

In the system disclosed in Jpn. Pat. Appln. KOKAI Publication No. 2006-254204, for example, a protected area is used to store an encrypted counter value indicating the frequency of applications of a decrypting key bundle (distribution key bundle). The protected area is a storage area which can be accessed only from a program executing portion having certain secret information. As a device having the protected area, for example, a Secure Digital (SD) card is provided. When the SD card is held by a user's terminal including a program executing portion having a device key, the SD card and program executing portion commonly have the same session key via authentication and key exchange processes (AKE). Then, the program executing portion inputs and outputs data encrypted by use of the session key to and from the SD card to set a state in which the read/write operation can be performed with respect to the protected area of the SD card. Further, if the program executing portion has no device key, the authentication process is performed in failure and the read/write operation with respect to the protected area cannot be performed. If the session key is not known, data of the protected area cannot be correctly read/written.

Generally, a storage medium having the protected area includes a general area which can be subjected to a read/write operation without performing the authentication process, an encrypted content is recorded in the general area, for example, and the decrypting key of the encrypted content is recorded in the protected area in some cases. In this case, the program executing portion having secret information reads the decrypting key from the protected area so as to decrypt and reproduce the encrypted content.

Further, as another technique using the protected area, for example, a technique for restoring original data from data groups which are additionally stored in a distributed form in a plurality of existing lists based on an additional file list stored in a stable location (protected area) to which the third party cannot access is known (for example, refer to Jpn. Pat. Appln. KOKAI Publication No. 2001-282621).

As a recording medium having no protected area, generally, a hard disk drive (HDD, hereinafter simply referred to as a hard disk) is known. The hard disk is widely used in a personal computer and the like as a recording medium for given data which is not limited to the contents. In the case of a general hard disk, a protected area which requires an authentication process is not provided and access is not limited.

However, if an area similar to a protected area can be structured in a recording medium such as a hard disk to which access can be freely made, it is preferable from the viewpoint of protecting stored data. In this case, the “area similar to the protected area” indicates an area in which access is not limited and which is protected (by the technique such as the secret distributing technique and encrypting technique other than the access limitation technique). The protected area is an area protected by access limitation. A method for structuring an area similar to the protected area in a recording medium in which access is not limited is explained below.

First, a protected area master key used to encrypt information recorded in the area similar to the protected area is prepared. The protected area master key is also recorded on the hard disk but it is impossible to completely prevent access to the protected area master key from the viewpoint of the property of the hard disk.

However, since various programs such as an OS are used to read or write information with respect to the hard disk, it becomes difficult to specify the protected area master key if the recording position of the protected area master key is made unclear. More specifically, for example, if the protected area master key is distributed as a plurality of distributed information items by use of a threshold value secret distribution method and the distributed information items are recorded in plural locations of the hard disk, the recording position of the protected area master key can be made unclear. As the threshold value secret distribution method, for example, a method called a (k, n) threshold value secret distribution method is proposed by Shamir in 1979 (for example, refer to A. Shamir; “How to Share a Secret”, Communication of the ACM, 22, 11, pp. 612 to 613 [1979]).

In the (k, n) threshold value secret distribution method, secret information is divided into n distributed information items, and original secret information can be restored by collecting desired k information items from the n distributed information items, but information relating to the original secret information cannot be attained at all based on the (k−1) distributed information items. That is, the (k, n) threshold value secret distribution method has a secret information restoring characteristic with the threshold value k set as a boundary (1<k≦n). Therefore, according to the (k, n) threshold value secret distribution method, the management process can be performed such that the original secret information can be safely protected even if distributed information items of (k−1) or less are leaked and the original secret information can be restored even if distributed information items of (n−k) or less are lost.

However, if distributed information items of the protected area master key are simply stored in a distributed form by use of the (k, n) threshold value secret distribution method, there occurs a possibility that the protected area master key and record information before encryption can be restored by backup-restoring distributed information items and record information encrypted by use of the protected area master key in a case where the recording position of the distributed information items is known. The “backup-restoring” is a process for copying record information in a storage area to another location and writing back the copied information to the original storage area after rewriting the record information to restore the record information before rewriting.

Therefore, it is important to update the protected area master key each time the record information in the storage area is rewritten and make unclear the recording positions of distributed information items relating to the protected area master key after updating from the viewpoint of preventing the backup-restoring process. This is because the protected area master key after updating and record information before encryption can be restored as described before if the recording positions of the distributed information items are made clear (for example, refer to Toru Kambayashi, Kenji Shimoda, Hiroyuki Sakamoto, “Content Protection for SD Memory Card”, Toshiba Review, Toshiba Inc. 2003, Vol. 58 No. 6, pp. 32 to 35).

However, in the method for structuring the area similar to the protected area, in a case where the recording positions of the respective distributed information items are kept the same at each time, there occurs a problem that the backup-restoring process can be performed if the recording position is once made clear.

### BRIEF SUMMARY OF THE INVENTION

An object of this invention is to provide a data processing apparatus and a program capable of making it difficult to specify a recording position of distributed information stored in a storage device in which access is not limited.

In a first aspect of the present invention, there is provided a data processing apparatus capable of updating and writing a plurality of distributed information items generated based on to-be-held secret information with respect to a storage device in which access is not limited, comprising: a distributed information generation device configured to generate a plurality of distributed information items updated this time according to secret information to be held this time based on a threshold value secret distribution method, a recording position selecting device configured to select recording positions of the distributed information items updated this time to leave behind distributed information items of a number less than a threshold value among the plurality of distributed information items updated last time or leave behind none of the above distributed information items with respect to a plurality of distributed information items updated and stored in the storage device, and a distributed information writing device configured to write the distributed information items updated this time to the storage device based on the selected recording positions.

In a second aspect of the present invention, there is provided a data processing apparatus capable of updating and writing a plurality of distributed information items generated based on to-be-held secret key information with respect to a storage device in which access is not limited, comprising: a file input device configured to input a file by an operation of an operator, a file key generation device configured to generate file key information according to the file, a file encrypting device configured to encrypt the file by use of the file key information and write the thus obtained encrypted file to the storage device, a key encrypting device configured to encrypt a key management file containing file addresses of the file key information and encrypted file and file addresses of different file key information and different encrypted file stored in the storage device by use of the secret key information and write the thus obtained encrypted key management file to the storage device, a distributed information generation device configured to generate a plurality of distributed information items updated this time according to secret key information to be held this time based on a threshold value secret distribution method, a recording position selecting device configured to select recording positions of the distributed information items updated this time to leave behind distributed information items of a number less than a threshold value among the plurality of distributed information items updated last time or leave behind none of the above distributed information items with respect to a plurality of distributed information items updated and stored in the storage device, a distributed information writing device configured to write the distributed information items updated this time to the storage device based on the selected recording positions, a device configured to read the distributed information items updated this time from the storage device, a key restoring device configured to restore secret key information from the read distributed information items by use of the threshold value secret distribution method, a device configured to decrypt the encrypted key management file in the storage device based on the restored secret key information to obtain a key management file, and a device configured to decrypt a corresponding encrypted file in the storage device based on corresponding file key information in the key management file and a file address input from an exterior to obtain a file.

The first and second aspects are expressed by the “apparatus”, but are not limited to this and the apparatus and a set of apparatuses can be expressed by a “program”, “computer-readable recording medium having a program stored therein” or “method”.

In the first aspect, it is possible to make it difficult to specify the recording positions of distributed information items stored in the storage device in which access is not limited since the recording positions of the respective distributed information items are made different at each time by making a configuration to write distributed information items updated this time to the storage device so that distributed information items of a number less than a threshold value among a plurality of distributed information items updated last time will be left behind or will not be completely left behind.

In the second aspect, an operation of protecting a plurality of files by encryption can be attained in addition to the same operation as that of the first aspect.

### BRIEF DESCRIPTION OF THE SEVERAL VIEWS OF THE DRAWING

FIG. 1 is a schematic diagram showing the configuration of a data processing apparatus according to a first embodiment of this invention.

FIG. 2 is a schematic diagram for illustrating distributed information items in the above embodiment.

FIG. 3 is a flowchart for illustrating an operation in the above embodiment.

FIG. 4 is a schematic diagram for illustrating the operation in the above embodiment.

FIG. 5 is a flowchart for illustrating an operation in the above embodiment.

FIG. 6 is a schematic diagram for illustrating the operation in the above embodiment.

FIGS. 7, 8 and 9 are schematic diagrams showing modifications of the above embodiment.

FIG. 10 is a schematic diagram for illustrating distributed information items applied to a data processing apparatus according to a second embodiment of this invention.

FIG. 11 is a flowchart for illustrating an operation in the above embodiment.

FIG. 12 is a schematic diagram for illustrating the operation in the above embodiment.

FIG. 13 is a schematic diagram for illustrating the sequence of updating distributed information items applied to a data processing apparatus according to a third embodiment of this invention.

FIG. 14 is a schematic diagram showing the configuration of a data processing apparatus according to a fourth embodiment of this invention.

FIG. 15 is a schematic diagram for illustrating a protected area master key in the above embodiment.

FIG. 16 is a schematic diagram showing the configuration of an encrypting key management file in the above embodiment.

FIG. 17 is a flowchart for illustrating an operation in the above embodiment.

FIG. 18 is a schematic diagram for illustrating the operation in the above embodiment.

FIG. 19 is a flowchart for illustrating an operation in the above embodiment.

FIG. 20 is a schematic diagram for illustrating the operation in the above embodiment.

### DETAILED DESCRIPTION OF THE INVENTION

Embodiments of the present invention will be described with reference to the accompanying drawings. In the following apparatuses, a hardware configuration or a combined configuration of a hardware source and software can be used for each apparatus. As shown in FIGS. 1 and 14, as the software of the combined configuration, a program which is previously installed from a network or storage medium M on a computer of a corresponding data processing apparatus 10 to realize a function of the corresponding apparatus is used.

### First Embodiment

FIG. 1 is a schematic diagram showing the configuration of a data processing system having a data processing apparatus according to a first embodiment of this invention. The data processing system 100 includes a data processing apparatus 10 as a client apparatus and a data storage device 20 in which access is not limited.

The data processing apparatus 10 includes an interface portion 11 and secret information management portion 12.

The interface portion 11 has an interface function between the data storage device 20 and the internal portion of the data processing apparatus 10. For clarifying the explanation, the description to the effect that the input/output operations with respect to both of the apparatus 10 and device 20 are performed via the interface portions 11, 21 is appropriately omitted.

The secret information management portion 12 includes a secret information generating portion 12-1, secret distribution processing portion 12-2, distributed information management portion 12-3 and secret distribution restoring portion 12-4.

The secret information generating portion 12-1 has a function of generating secret information to be held this time in response to the operation of an operator and a function of supplying the thus generated secret information to the secret distribution processing portion 12-2.

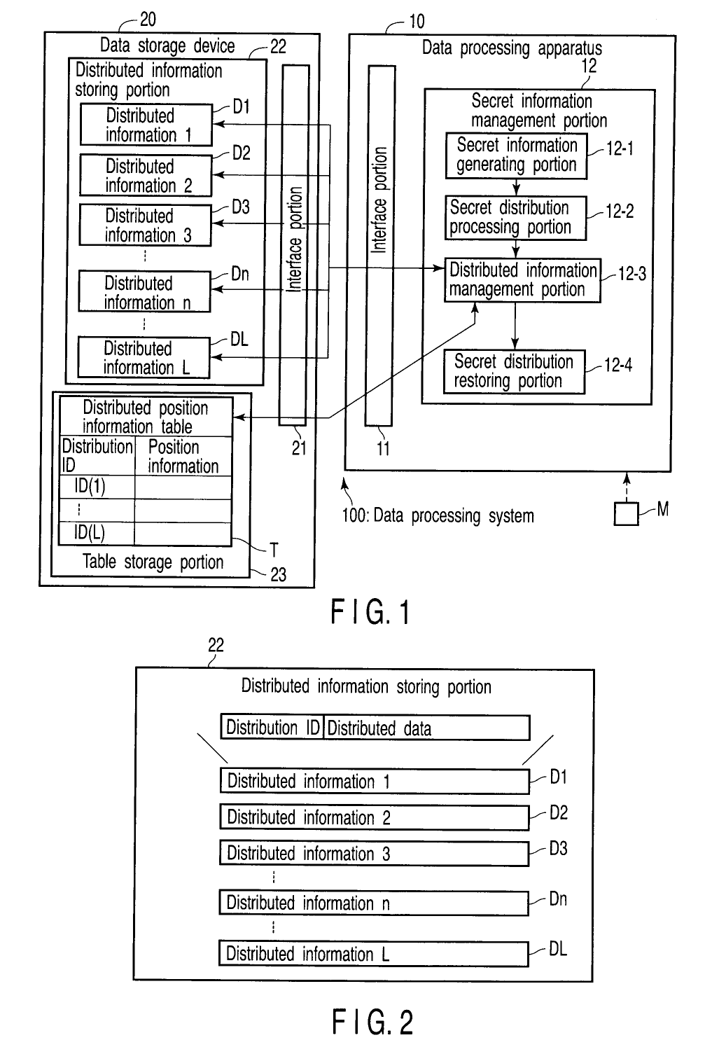

The secret distribution processing portion 12-2 has a function of generating a plurality of distributed information items to be updated this time according to the secret information supplied from the secret information generating portion 12-1 based on a (k, n) threshold value secret distribution method utilizing a threshold value k and distribution number n and supplying the thus obtained distributed information items to the distributed information management portion 12-3. As shown in FIG. 2, the distributed information D is configured by a distribution ID and distributed data and written to a distributed information storing portion 22 which will be described later.

The distributed information management portion 12-3 has the following functions (f12-3-1) to (f12-3-5).

(f12-3-1): The function of selecting recording positions of respective distributed information items to be updated this time so that distributed information items of a number less than the threshold value k among n distributed information items updated last time are left behind with respect to L (k<L<2k) distributed information items D1 to DL updated and stored in the distributed information storing portion 22 when the respective distributed information items are received from the secret distribution processing portion 12-2.

(f12-3-2): The function of writing respective distributed information items to be updated this time to the distributed information storing portion 22 based on the selected recording positions.

(f12-3-3): The function of writing distribution IDs and position information items corresponding thereto to a distributed position information table T in a table storage portion 23 with respect to the written distributed information items.

(f12-3-4): The function of reading at least k distributed information items D1 to Dk from the distributed information storing portion 22 by referring to the distributed position information table T in the table storage portion 23 in response to the operation of the operator.

(f12-3-5): The function of supplying the read distributed information items D1 to Dk to the secret distribution restoring portion 12-4.

The recording positions of the distributed information items may be selected by use of random numbers, for example. Further, positions different from the recording positions used at the preceding time may be intentionally selected by referring to the table storage portion 23. The number of operations of writing distributed information items in each cycle is not limited to n and can be freely set to any value if it is set in the range of k and n.

The secret distribution restoring portion 12-4 has a function of subjecting distributed information items received from the distributed information management portion 12-3 to a restoring process based on a threshold secret distribution method and restoring secret information.

The data storage device 20 includes the interface portion 21, distributed information storing portion 22 and table storage portion 23.

The interface portion 21 has an interface function between the data processing apparatus 10 and the internal portion of the data storage portion 20.

The distributed information storing portion 22 has L storage areas which can be subjected to a read/write operation by use of the data processing apparatus 20 and store L distributed information items D1, D2, Dn, . . . , DL. In this case, it is preferable to set the relation of n<L<2k. The reason why the relation of n<L is preferable is that there occurs a problem that n distributed information items may be recorded in the same positions at each time if n=L and there occurs a problem that n distributed information items cannot be recorded if n>L. Further, the reason why the relation of L<2k is preferable is that there occurs a problem that k (=n) distributed information items before updating are left behind (a problem that the secret information before updating can be restored) even if n (=k) distributed information items after updating are written at the time of n=k in the case of L=2k. The same problem occurs in the case of 2k<L.

However, it is not indispensable to set the relation of n<L<2k and the relation can be adequately changed depending on values of (k, n). For example, in order to avoid the case wherein (k, n) is set to (3, 7) and L which satisfies the relation of n<L<2k is not present (for example, the case of 7<L<2·3), it is possible to change the relation to the relation of k<L<2k, for example, and write k to (2k−2) distributed information items.

In the table storage portion 23, a distributed position information table which can be subjected to a read/write operation by use of the data processing apparatus 20 is stored. In the distributed position information table T, position information items (address information items) in the distributed information storage portion 22 are stored for respective distributed IDs with respect to the L distributed information items D1, D2, . . . , Dn, . . . , DL.

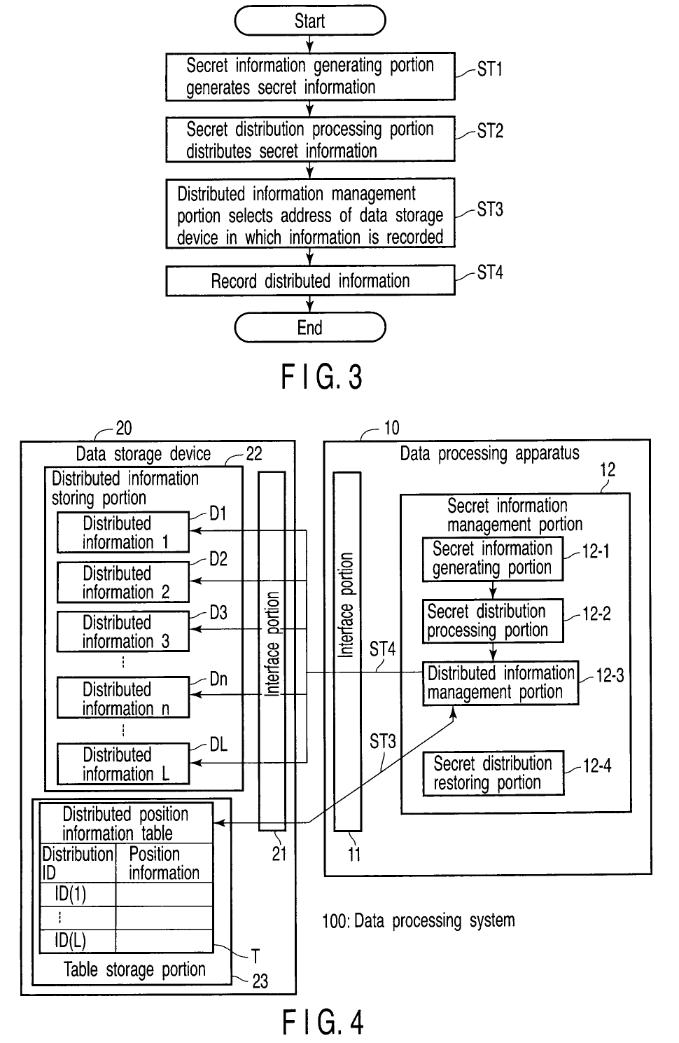

Next, the operation of the data processing apparatus with the above configuration is explained with reference to FIGS. 3 to 6.

(Recording Operation)

As shown in FIGS. 3 and 4, the secret information generating portion 12-1 generates secret information in response to the operation of the operator (ST1) and outputs the secret information to the secret distribution processing portion 12-2. The secret information is not necessarily generated by the secret information generating portion 12-1 but can be acquired from the exterior in some cases.

The secret distribution processing portion 12-2 distributes the secret information as n distributed information items D1 to Dn based on the (k, n) threshold value secret distribution method (ST2) and supplies the distributed information items D1 to Dn to the distributed information management portion 12-3.

When receiving the distributed information items D1 to Dn, the distributed information management portion 12-3 refers to the distributed position information table T stored in the table storage portion 23 of the data storage device 20 to select recording positions of the respective distributed information items D1 to Dn so as to leave behind distributed information items of a number less than the threshold value k among n distributed information items D1′ to Dn′ updated last time (ST3). The recording position of, for example, at least one distributed information Di as the number of the distributed information items less than the threshold value k is selected to be different from the recording positions of the n distributed information items D1′ to Dn′ updated last time.

After this, the distributed information management portion 12-3 writes the n distributed information items D1 to Dn to n selected storage areas among the L storage areas of the distributed information storing portion 22 (ST4). Further, the distributed information management portion 12-3 writes distribution IDs and position information items corresponding thereto with respect to the written distributed information items D1 to Dn to the distributed position information table T in the table storage portion 23.

(Restoring Operation)

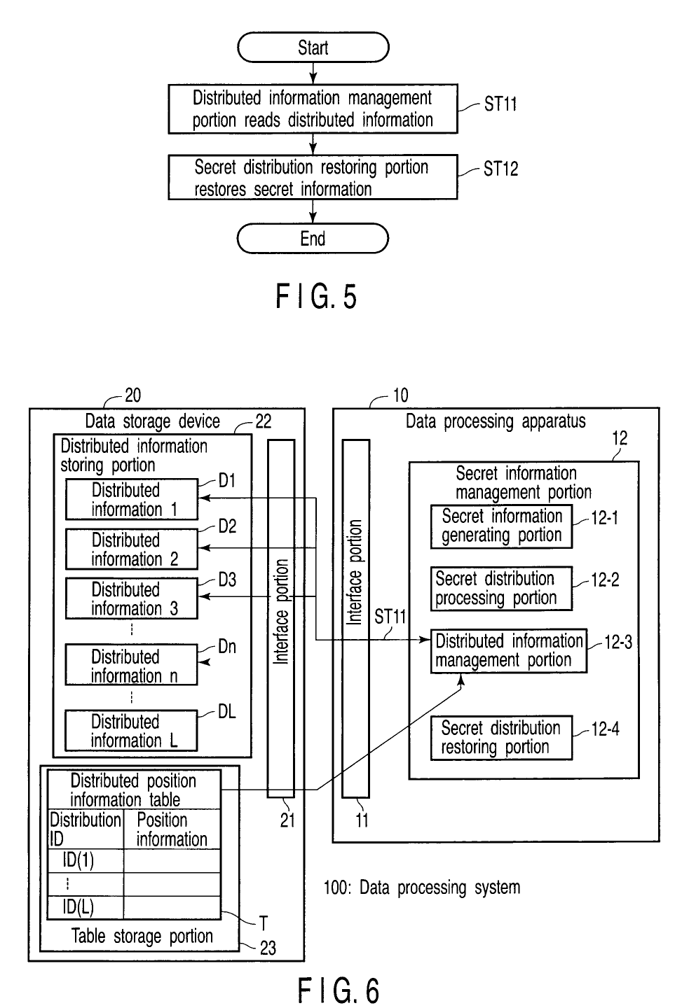

As shown in FIGS. 5 and 6, the distributed information management portion 12-3 refers to the distributed position information table T in the table storage portion 23 in response to the operation of the operator to read k distributed information items D1 to Dk from the distributed information storing portion 22 (ST11) and supplies the k distributed information items D1 to Dk to the secret distribution restoring portion 12-4.

The secret distribution restoring portion 12-4 restores secret information based on the k distributed information items D1 to Dk by use of the threshold value secret distribution method (ST12).

As described above, according to the present embodiment, with the configuration in which the distributed information items D1 to Dn updated this time are written to the distributed information storing portion 22 so as to leave behind distributed information items of a number less than the threshold value k among the n distributed information items D1′ to Dn′ updated last time, since the recording positions of the respective distributed information items are made different for each time, it becomes possible to make it difficult to specify the recording positions of the distributed information items stored in the storage device in which access is not limited.

The present embodiment may be modified into a configuration obtained by omitting the table storage portion 23 as shown by the following modifications (1) to (5).

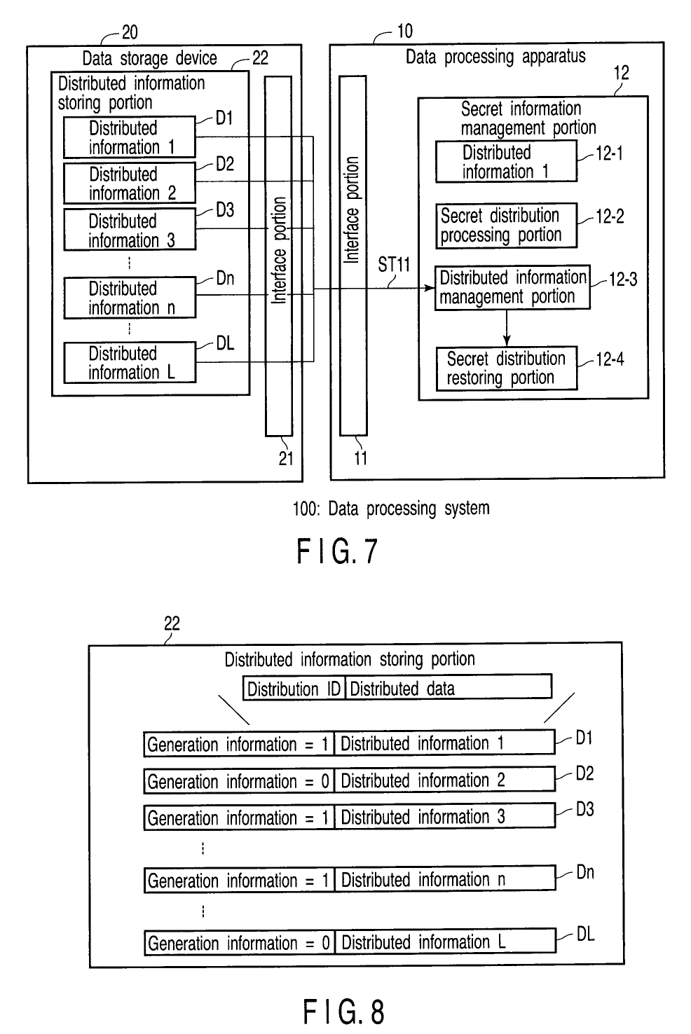

(1) As shown in FIG. 7, the distributed information management portion 12-3 reads all of the L distributed information items D1 to DL in the distributed information storing portion 22 (ST11) and supplies the distributed information items D1 to DL to the secret distribution restoring portion 12-4. The secret distribution restoring portion 12-4 can appropriately select k distributed information items D1 to Dk from the L distributed information items D1 to DL and restore secret information based on the k distributed information items D1 to Dk by use of the threshold value secret distribution method.

(2) As shown in FIG. 8, the distributed information items D1 to DL may be configured to have generation information items containing generation numbers added thereto. The generation number is a number updated each time the distributed information is updated and desired natural numbers such as 0, 1, 2, . . . can be used in the range of the generation numbers. In this case, as shown in FIG. 7, the distributed information management portion 12-3 reads all of the L distributed information items D1 to DL in the distributed information storing portion 22 (ST11), selects distributed information items having generation information of the newest number and supplies the distributed information items to the secret distribution restoring portion 12-4. Further, the generation information can be made difficult to be identified from the exterior by encrypting the generation information and distributed information.

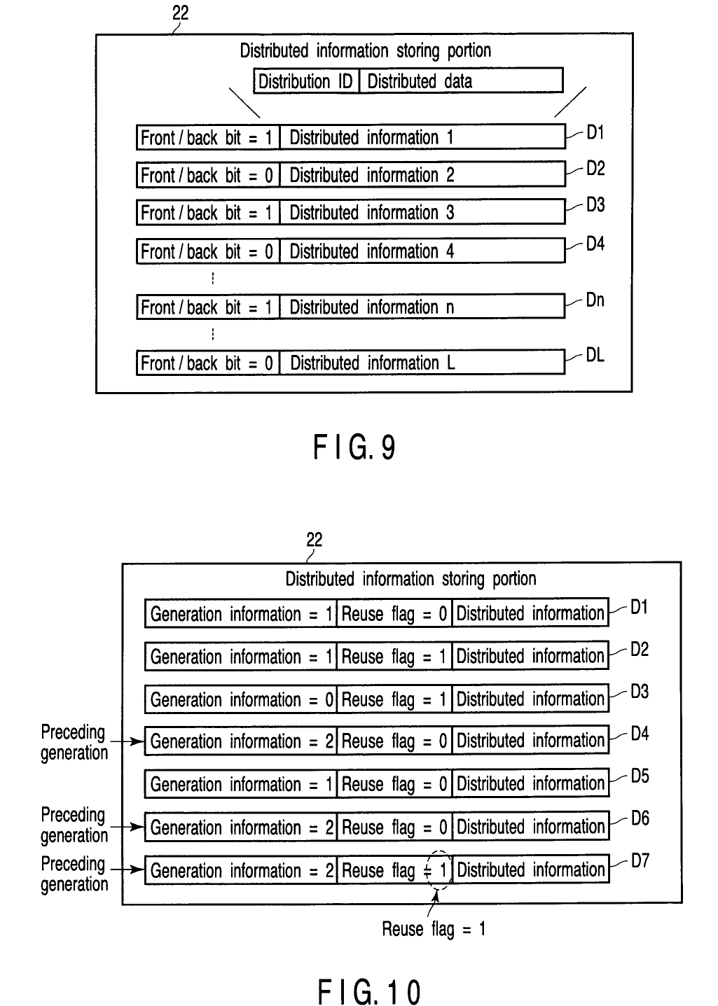

(3) As shown in FIG. 9, the distributed information items D1 to DL may be configured to have front/back bits “0” or “1” as generation information items containing generation numbers added thereto. The front/back bit is a number updated each time the distributed information is updated and values of the front/back bits are “0” and “1”. In this case, as shown in FIG. 7, the distributed information management portion 12-3 reads all of the L distributed information items D1 to DL in the distributed information storing portion 22 (ST11), compares the number of front/back bits “0” with the number of front/back bits “1”, selects distributed information items D1, D3, Dn, . . . having the larger number of front/back bits, for example, “1” and supplies the distributed information items D1, D3, . . . , Dn, . . . to the secret distribution restoring portion 12-4. In this case, since the selection is made based on a majority rule, it becomes unnecessary to manage what generation is the newest.

(4) It is possible to make it difficult to analyze generation information, distributed position information table T and distributed information items D1 to DL by encrypting them. Further, it is advantageous from the viewpoint of detecting data falsification to form a modified configuration in which verify information used to verify whether restored secret information is correct or not is recorded in a portion different from the distributed information storing portion 22. In this case, as the verify information, a digital signature of the data processing apparatus 10 with respect to secret information, a hash value with respect to secret information and the like can be appropriately used. Further, as the portion different from the distributed information storing portion 22, for example, a desired storage area of the data storage device 20 or data processing apparatus 10 can be used.

(5) The system of the threshold value secret distribution method can be changed when secret information is updated. For example, it is possible to make switching between a (3, 3) threshold value secret distribution method and a (3, 4) threshold value secret distribution method. According to this modification, it is possible to make it more difficult to specify the secret information distribution method.

### Second Embodiment

A data processing apparatus according to a second embodiment of this invention is explained with reference to FIG. 1. That is, the present embodiment is a modification of the first embodiment and a configuration is made in which m (m≦k−1) distributed information items among n distributed information items used last time are contained in n distributed information items used this time and secret information is distributed by simultaneously using an actually updated portion ((n−m) distributed information items used this time) and a portion (m distributed information items used last time) different from the above portion.

More specifically, for example, when secret information is set to a₀ and is distributed by use of the (k, n) threshold value secret distribution method, the threshold value secret distribution method is realized by freely selecting (k−1) coefficients a₁, a₂, . . . , aₖ₋₁, preparing a (k−1)th degree polynomial of x, y, where y=a₀+a₁×x+a₂×x²+ . . . +aₖ₋₁×x^{k-1}, and freely selecting different points (x₁, y₁), . . . , (xₙ, yₙ) on the (k−1)th degree polynomial. When k distributed information items are collected from the n distributed information items distributed at the restoring time, the set (k−1)th degree polynomial can be specified and secret information a₀ can be derived.

In the present embodiment, the (k, n) threshold value secret distribution method is improved as follows:

That is, when m (m≦k−1) distributed information items used last time are contained in n distributed information items used this time, secret information is substituted into a₀′ and the m distributed information items used last time are substituted into points (x, y) in a polynomial of y=a₀+a₁×x+a₂×x²+ . . . +aₖ₋₁×x^{k-1} to obtain m simultaneous equations.

Then, if (k−1−m) values are randomly and independently set from coefficients a₁′ to aₖ₋₁′, the remaining coefficients are determined. After this, (n−m) distributed information items used as new distributed information items (x₁, y₁), (xₙ₋ₘ, yₙ₋ₘ) are freely selected.

Next, as shown in FIG. 10, generation information items and reuse flags are added to seven (in the case of L=7) distributed information items D1 to D7 in the distributed information storing portion 22. This example is a case wherein generation information items indicating the distributed information items D4, D6, D7 used last time are set to “2” and the number of distributed information items (D7) to be reused among the distributed information items D4, D6, D7 used last time is set to “1”.

As the concrete configuration, the secret distribution processing portion 12-2 has a function of reading distributed information items of a number less than the threshold value among the distributed information items updated last time and a function of generating a plurality of distributed information items updated this time to contain the read distributed information items used last time and to-be-held secret information items by use of the threshold value secret distribution method.

Next, the operation of the data processing apparatus with the above configuration is explained with reference to FIGS. 10 to 12.

(Recording Operation)

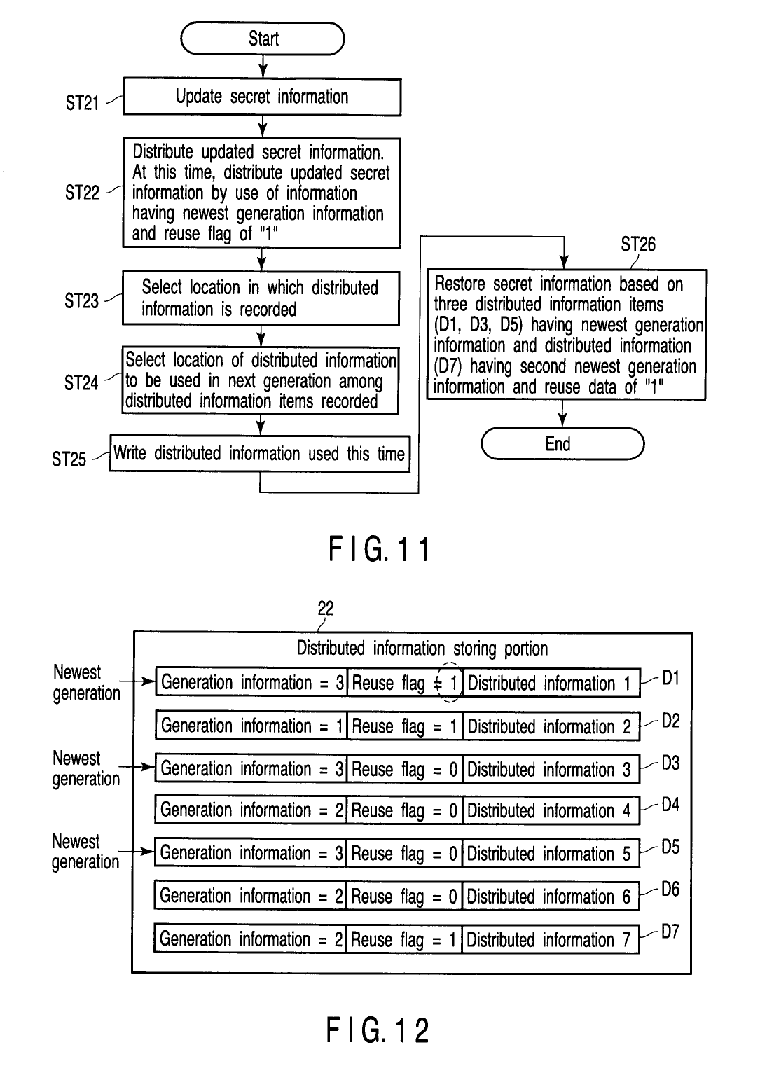

It is supposed now that seven distributed information items D1 to D7 are stored in the distributed information storing portion 22 as shown in FIG. 10. At this time, as shown in FIG. 11, the secret information generating portion 12-1 generates updated secret information in response to the operation of the operator (ST21) and supplies the updated secret information to the secret distribution processing portion 12-2.

When receiving the updated secret information, the secret distribution processing portion 12-2 reads distributed information items of m (m≦k−1) less than the threshold value among distributed information items D1′ to Dn′ updated last time from the distributed information storing portion 22.

Next, the secret distribution processing portion 12-2 distributes secret information as (n−m) distributed information items D1 to Dn−m used this time and m distributed information items Dn−m+1 to Dn used last time by use of the (k, n) threshold value secret distribution method. For example, m simultaneous equations are derived by preparing the equation of y=a₀+a₁×x+a₂×x²+ . . . +aₖ₋₁×x^{k-1} and substituting the m distributed information items Dn−m+1 to Dn used last time into the above equation. After this, coefficients a₀ to aₖ₋₁ are randomly and independently set to satisfy the derived simultaneous equations. Then, the remaining distributed information items D1 to Dn−m are created.

Next, a case of n=k=4 and m=1 is taken as an example and explained.

When receiving the updated secret information, the distributed information management portion 12-3 selects the distributed information D7 which has the newest generation information and a reuse flag of “1” among the distributed information items D1 to D7 in the distributed information storing portion 22 shown in FIG. 10 as distributed information to be contained in the distributed information used this time among the distributed information items D4, D6 and D7 used last time.

Next, the distributed information management portion 12-3 distributes the updated secret information as three distributed information items Da, Db, Dc used this time and one distributed information D7 used last time based on the (3, 4) threshold value secret distribution method (ST22). At this time, generation information items of the distributed information items Da, Db, Dc are set to the newest value “3”.

The distributed information management portion 12-3 selects areas used to update the three distributed information items Da, Db, Dc used this time among the storage areas of the distributed information items D1 to D7 in the distributed information storing portion 22 shown in FIG. 10 (ST23). In this case, it is sufficient to select storage areas other than the storage area of the distributed information D7 used for restoring, and for example, it is supposed that the storage areas of the distributed information items D1, D3, D5 are selected.

Further, for example, the storage area of the distributed information D1 is selected as the storage area of the distributed information to be reused among the storage areas of the distributed information items D1, D3, D5 (ST24). At this time, the reuse flag of the distributed information D1 is set to “1”.

After this, as shown in FIG. 12, the distributed information management portion 12-3 writes the distributed information items D1, D3, D5 used this time to the distributed information storing portion 22 (ST25).

Thus, the distributed information updating process is terminated. At the secret information restoring time, the three distributed information items D1, D3, D5 used this time and the distributed information D7 used last time are read.

Next, the secret information restoring operation is explained.

As shown in FIGS. 11 and 12, the distributed information management portion 12-3 reads the three distributed information items D1, D3, D5 of the newest generation from the distributed information storing portion 22, reads one distributed information D7 of the preceding generation having the reuse flag “1” and supplies the four distributed information items D1, D3, D5, D7 to the secret distribution restoring portion 12-4 in response to the operation of the operator.

The secret distribution restoring portion 12-4 restores secret information from the four distributed information items D1, D3, D5, D7 by use of the (3, 4) threshold value secret distribution method (ST26).

As described above, according to the present embodiment, the effect that specification of the location of the distributed information of the secret information can be made difficult since the m distributed information items used last time other than the (n−m) distributed information items updated this time can be also used for restoring can be attained in addition to the effect of the first embodiment.

### Third Embodiment

A data processing apparatus according to a third embodiment of this invention is explained with reference to FIG. 1. That is, the present embodiment is a modification of the first or second embodiment and a configuration is made in which (k−1) distributed information items used this time are written while the k distributed information items used last and then next one (kth one of the distributed information items used this time) distributed information is written over one of the k distributed information items used last time is kept left so that a state other than the state before or after updating will not occur at the write time with respect to the distributed information storing portion 22. The state other than the state before or after updating indicates a state in which both of the secret information items before and after updating cannot be restored and a state in which both of the secret information items before and after updating can be restored.

In this case, the distributed information management portion 12-3 has the following functions (f12-3-6) and (f12-3-7) in addition to the functions (f12-3-1) to (f12-3-5) described before.

(f12-3-6): The function of writing distributed information items of “threshold value k−1” among the distributed information items D1 to Dn updated this time to the distributed information storing portion 22 so as to set the number of distributed information items D1′ to Dn′ updated last time equal to the “threshold value k” when the number of distributed information items D1′ to Dn′ updated last time and stored in the distributed information storing portion 22 is larger than the threshold value k.

(f12-3-7): The function of writing one of the distributed information items updated this time over the distributed information updated last time when the number of distributed information items updated last time and stored in the distributed information storing portion 22 is set equal to the “threshold value k”.

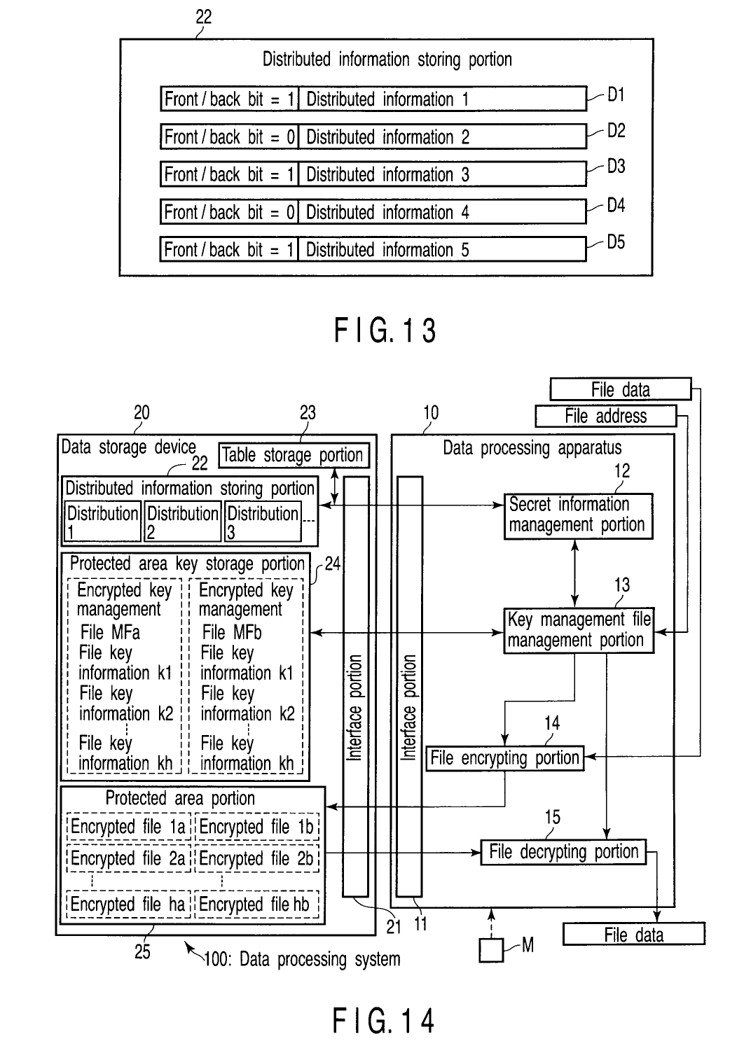

FIG. 13 is a diagram for concretely illustrating the sequence of updating distributed information items by use of the (3, 3) threshold value secret distribution method. In this state, secret information can be restored by using distributed information items D1, D3, D5 determined based on the majority rule of front/back bits. It is supposed that three distributed information items D2′, D4′, D5′ generated by the threshold value secret distribution method written over the distributed information items D2, D4, D5 when secret information is updated. In this case, since the first two distributed information items D2, D4 are distributed information items used in a cycle before the preceding cycle and are not used before updating, the distributed information items are first overwritten. After this, the distributed information is written over the distributed information D5 which has been used before updating. At this time, it is not limited to D5 but can be similarly applied to D1 or D3. In either case, secret information can be switched from the state before updating to the state after updating at the same time that the distributed information D5′ is written according to the sequence in which the distributed information items are written over the distributed information items D2, D4 which are not used before updating and then the distributed information is written over the distributed information D5 which has been used before updating.

A case wherein distributed information items D1 to Dn are recorded by use of the (k, n) threshold value secret distribution method in L storage areas in which distributed information items D1′ to DL′ of plural generations are recorded by use of the (k′, n′) threshold value secret distribution method is explained. First, (k−1) distributed information items D1 to Dk−1 to be updated are recorded to erase (k′−n′) or more previous distributed information items Dk+1′ to DL′. In the recording process, the previous distributed information items can be simultaneously erased by overwriting.

The sequence of recording and then erasing is desirable by taking into consideration that the recording process is interrupted although the sequence of the recording process is not specifically limited. After this, new kth distributed information is written to the position of the previous distributed information. Since the number of previous distributed information items becomes (k−1) when the writing process is terminated, the previous secret information cannot be restored. At the same time, since the number of distributed information items after updating becomes k, it becomes possible to restore the secret information after updating.

As described above, according to the present embodiment, the effect that the state other than the state before or after updating can be prevented from occurring at the time of writing to the distributed information storing portion 22 in the configuration in which (k−1) distributed information items used this time are written while k distributed information items used last time are kept left and then the next one distributed information item (kth one of the distributed information items used this time) is written over one of the k previous distributed information items can be attained in addition to the effect of the first embodiment.

### Fourth Embodiment

Next, a data processing apparatus according to a fourth embodiment of this invention is explained.

FIG. 14 is a schematic diagram showing the configuration of a data processing system having a data processing apparatus according to the fourth embodiment of this invention. For example, a data processing system 100 includes a data processing apparatus 10 configured by an information processing apparatus such as a personal computer and a data storage device 20 configured by a storage device such as a hard disk which can be freely accessed.

The data processing apparatus 10 includes an interface portion 11, secret information management portion 12, key management file management portion 13, file encrypting portion 14 and file decrypting portion 15.

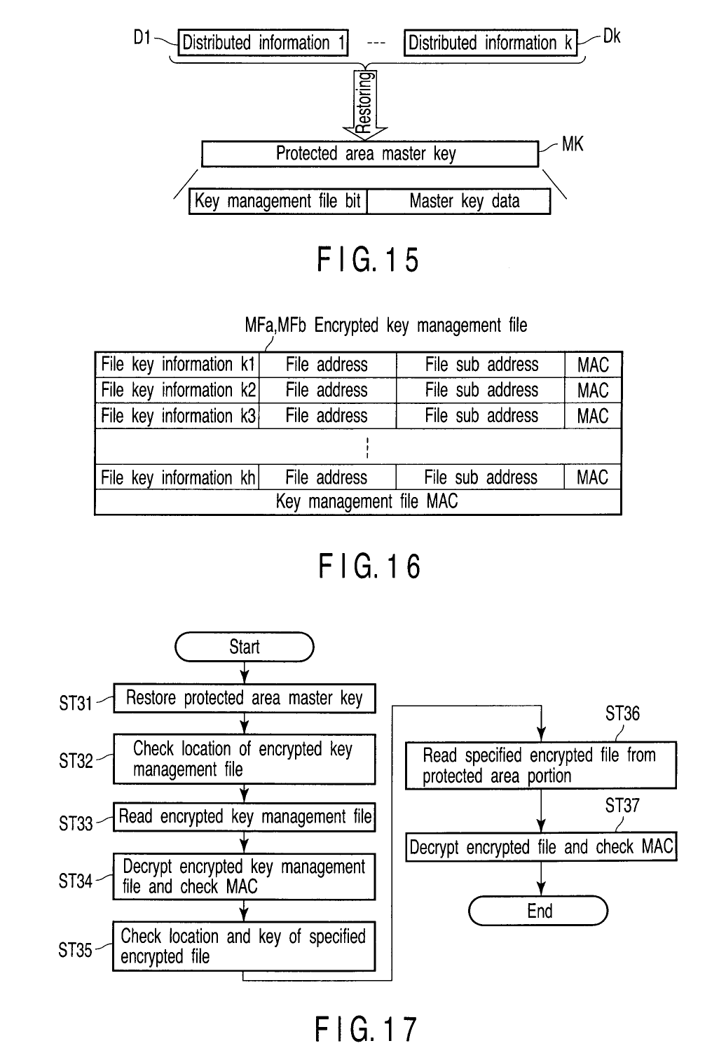

The interface portion 11 and secret information management portion 12 are the same those described before. However, a protected area master key MK as shown in FIG. 15 is used as secret information. The protected area master key MK has a key management file bit indicating one of encrypted key management files MFa and MFb and master key data obtained by encrypting the encrypted key management file MFa or MFb. The protected area master key MK is distributed as distributed information items D1 to Dn by use of the secret information management portion 12 and written to a distributed information storing portion 22. Further, the protected area master key MK is restored from the distributed information items D1 to Dn by use of the secret information management portion 12 and supplied to the key management file management portion 13.

The key management file management portion 13 has the following functions (f13-1) to (f13-4).

(f13-1): The function of generating file key information ki according to a file ia or ib input from the exterior in response to the operation of the operator.

(f13-2): The function of encrypting a key management file MFa or MFb containing a MAC value, file address and file sub address of an encrypted file ia or ib and file key information ki and a MAC value, file address and file sub address of another encrypted file and other file key information in a protected area portion 25 by use of the protected area master key MK and writing the thus obtained encrypted key management file MFa or MFb to a protected area key storage portion 24. In this case, the MAC value can be omitted.

(f13-3): The function of decrypting the encrypted key management file MFa or MFb in the protected area key storage portion 24 by use of the protected area master key MK supplied from the secret information management portion 12 to acquire a key management file MFa or MFb.

(f13-4): The function of supplying corresponding file key information, file address and file sub address to the file decrypting portion 15 based on the decrypted key management file MFa or MFb and the file address input from the exterior.

The file encrypting portion 14 has a function of inputting a file ia or ib by the operation of the operator and a function of encrypting the input file ia or ib by use of file key information ki and writing the thus obtained encrypted file ia or ib to the protected area portion 25.

The file decrypting portion 15 decrypts the corresponding encrypted file ia or ib in the protected area portion 25 based on the file key information, file address and file sub address received from the key management file management portion 13 to acquire a file ia or ib.

The data storage device 20 includes an interface portion 21, distributed information storing portion 22, table storage portion 23, protected area key storage portion 24 and protected area portion 25.

The interface portion 21, distributed information storing portion 22 and table storage portion 23 are the same as those described before.

The protected area key storage portion 24 is a storage area which can be subjected to a read/write operation by use of the data processing apparatus 10 and encrypted key management files MFa, MFb are stored therein.

As shown in FIG. 16, each of the encrypted key management files MFa, MFb includes h file key information items, file addresses, file sub addresses, MAC values and protected area management file MAC. In this case, since the encrypted key management files MFa, MFb have the same configuration except the correspondence relation between the a-series and b-series, a case of the encrypted key management file MFa is taken as an example and explained. The encrypted key management files MFa corresponds to the a-series encrypted files 1a to ha and the encrypted key management files MFb corresponds to the b-series encrypted files 1b to hb.

In this case, the a-series and b-series are two series indicating the states before and after updating. In the case of the encrypted key management files MFa, MFb, the state before updating is copied except one file key information ki (where i=1, 2, . . . , h), file address, file sub address and MAC value updated this time and a protected area management file MAC corresponding to the updating operation. For one file key information ki, file address, file sub address and MAC value updated this time and the protected area management file MAC corresponding to the updating operation, one of the two series indicates the state before updating and the other series indicates the state after updating.

Likewise, in the case of the encrypted files 1a to ha and 1b to hb, the state before updating is copied except one encrypted file ia or ib (where i=1, 2, . . . , h) updated this time in each of the a-series and b-series. Further, for one encrypted file ia or ib updated this time, one of the two series indicates the encrypted file ia or ib before updating and the other series indicates the encrypted file ib or ia after updating.

That is, even when the power source is turned OFF while the distributed information items D1 to Dn are being updated, the encrypted files 1a to ha or 1b to hb before or after updating can be restored by holding the encrypted key management files MFa, MFb before and after updating and the encrypted files 1a to ha and 1b to hb in the data storage device 20.

The file key information items k1 to kh in the encrypted key management file MFa correspond to the encrypted files 1a to ha in the protected area portion 25. The file key information items are key information items used to decrypt the encrypted files 1a to ha and key information items used to encrypt the files 1a to ha in the non-encrypted state and acquire encrypted files 1a to ha. For example, the file key information k1 corresponds to the encrypted file 1a in the protected area portion 25. The file key information is key information used to decrypt the encrypted file 1a and key information used to encrypt the file 1a in the non-encrypted state and acquire an encrypted file 1a.

The file addresses are address information items indicating the encrypted files 1a to ha and 1b to hb in the protected area portion 25. For example, the file address corresponding to the file key information k1 is address information commonly used for both of the encrypted files 1a and 1b in the protected area portion 25.

The file sub addresses are sub address information items indicating the encrypted files 1a to ha or encrypted files 1b to hb among the encrypted files 1a to ha and 1b to hb. For example, the file sub address corresponding to the file key information k1 in the encrypted key management file MFa is sub address information indicating the encrypted file 1a. That is, the recording position of the encrypted file 1a or 1b in the protected area portion 25 can be specified by combining the file address and file sub address.

MAC indicates a MAC value for the file key information, file address and file sub address.

The protected area management file MAC indicates a MAC value for h file key information items, file addresses, file sub addresses and MAC values.

The protected area portion 25 is a storage area which can be subjected to a read/write operation by use of the data processing apparatus 10 and encrypted files 1a to ha and 1b to hb before and after updating are stored therein for every h files.

Next, the operation of the data processing apparatus with the above configuration is explained with reference to FIGS. 17 to 20.

(Decrypting Operation)

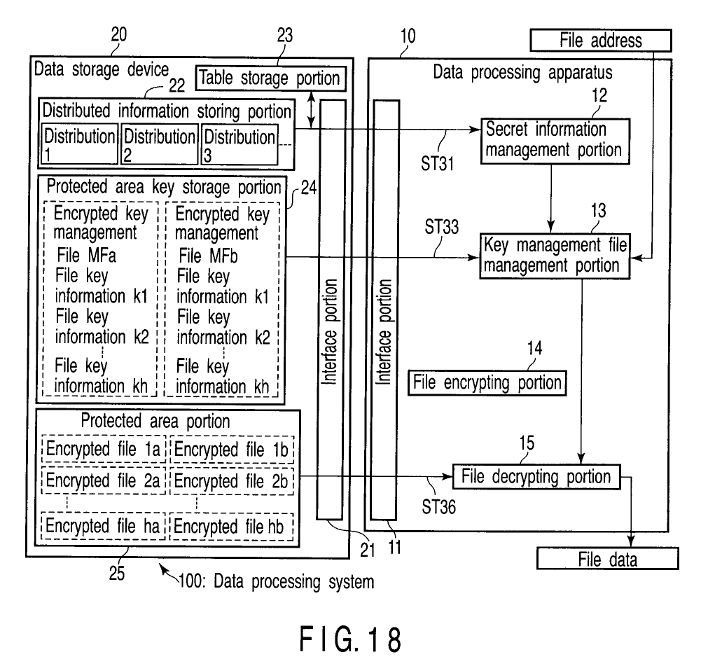

As shown in FIGS. 17 and 18, in the data processing apparatus 10, the secret information management portion 12 reads distributed information items D1 to Dn from the distributed information storing portion 22 as described before and restores a protected area master key MK as secret information (ST31). Then, it supplies the protected area master key MK to the key management file management portion 13.

The key management file management portion 13 checks the recording position of the encrypted key management file MFa or MFb according to a key management file bit of the protected area master key MK (ST32). The recording positions of the encrypted key management files MFa, MFb are previously held by the key management file management portion 13 at the updating time and one of the recording position of the encrypted key management file MFa and the recording position of the encrypted key management file MFb which is to be used is specified by use of the key management file bit.

The key management file management portion 13 reads a specified encrypted key management file, for example, MFa from the protected area key storage portion 24 (ST33). Further, the key management file management portion 13 decrypts the encrypted key management file MFa by use of master key data of the protected area master key MK and confirms the MAC value (not shown) of the encrypted key management file MFa (ST34).

Next, the key management file management portion 13 checks file key information, for example, k1 and file sub address (location) associated with a file address specified by the operator according to the encrypted key management file MFa based on the above file address (ST35).

After this, the key management file management portion 13 supplies the corresponding file key information k1, file address and file sub address to the file decrypting portion 15.

The file decrypting portion 15 reads an encrypted file 1a from the protected area portion 25 based on the file address and file sub address (ST36).

The file decrypting portion 15 performs a process of decrypting the encrypted file 1a based on the file key information k1 and confirms a MAC value (not shown) of the thus obtained file 1a (ST37).

The confirmation process of the MAC value in the steps ST34, ST37 is preferable from the viewpoint of verifying whether falsification is made or not, but is not indispensable and can be omitted.

(Recording Operation)

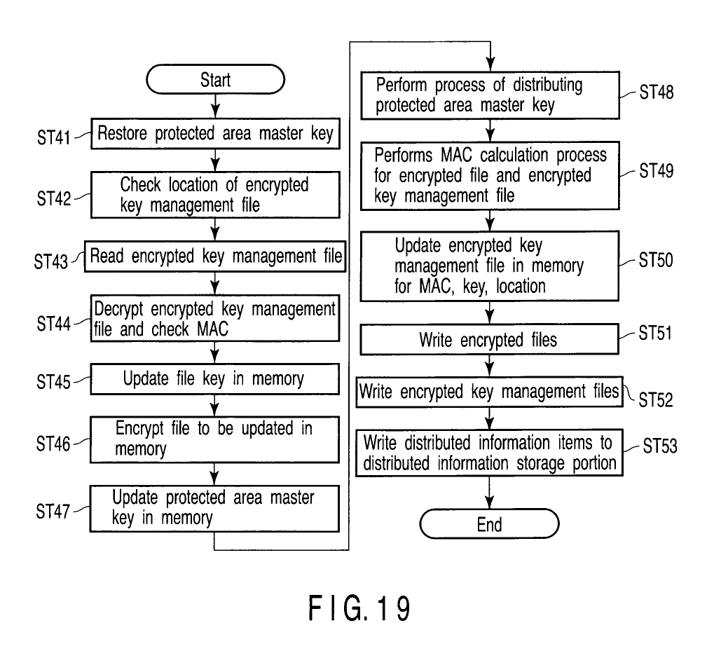

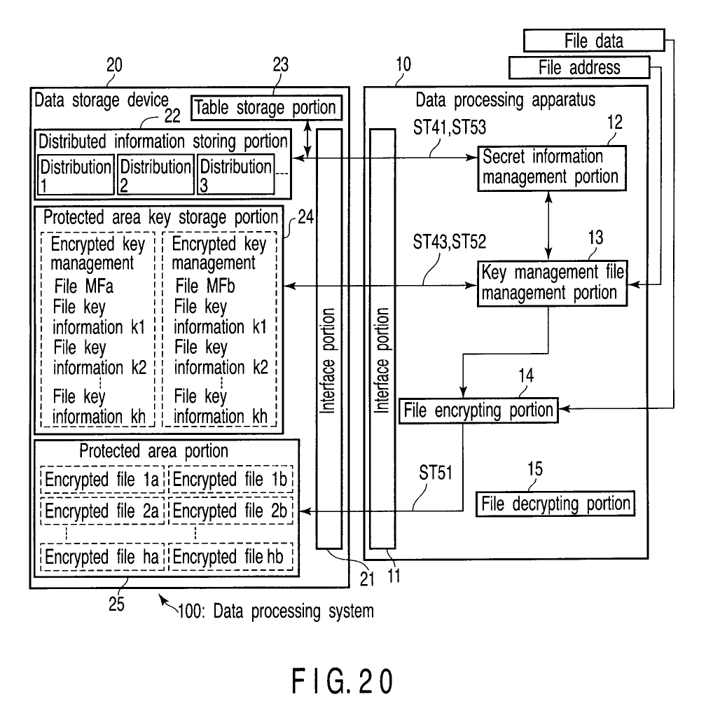

As shown in FIGS. 19 and 20, the data processing apparatus 10 performs the steps ST41 to ST44 in the same manner as the steps ST31 to ST34 to acquire a key management file MFa before updating.

Then, the key management file management portion 13 of the data processing apparatus 10 updates file key information, for example, k1 in a memory (not shown) (ST45). When receiving a file 1b to be updated by the operation of the operator, the file encrypting portion 14 performs an encrypting process for the to-be-updated file 1b based on the file key information k1 after updating in the memory (ST46). The secret information management portion 12 updates the protected area master key MK in the memory (ST47) and performs a process of distributing the thus updated protected area master key MK (ST48).

Further, the key management file management portion 13 performs a MAC calculation process for the updated encrypted file 1b and encrypted key management file MFb (ST49) and updates the encrypted key management file MFb in the memory. The updated contents are a MAC value, file key information k1, file address and file sub address (ST50). After this, information items in the memory are actually held in the data storage device 20.

The file encrypting portion 14 copies encrypted files 2a to ha before updating, writes the same as encrypted files 2b to hb and writes an encrypted file 1b after updating (ST51).

Thus, the encrypted files 1a to ha before updating, encrypted file 1b after updating and encrypted files 2b to hb after updating obtained by copying the encrypted files 2a to ha before updating are present in the protected area portion 25.

The key management file management portion 13 copies the encrypted key management file MFa before updating and writes the same as an encrypted key management file MFb and writes an encrypted key management file MFb after updating over the above encrypted key management file MFb (ST52). Thus, the encrypted key management file MFa before updating and encrypted key management file MFb after updating are present in the protected area key storage portion 24.

The secret information management portion 12 writes distributed information items D1 to Dn of the protected area master key MK (ST53). The step ST53 can be performed as described in the first to third embodiments.

As described above, according to the present embodiment, the effect that a plurality of files can be protected by encrypting can be attained in addition to the effects of the first to third embodiments.

Further, by holding the encrypted files 1a to ha, 1b to hb and encrypted key management files MFa, MFb before and after updating in the data storage device 20, the files 1a to ha or 1b to hb before or after updating can be restored even when the power source is turned OFF while the distributed information items D1 to Dn in the distributed information storage portion 22 are being updated (during the process of the step ST53).

The technique described above for the embodiment can be stored as a program to be executed by a computer in memory mediums including magnetic disks (Floppy™ disks, hard disks, etc.), optical disks (CD-ROMs, DVDs, etc.), magneto-optical disks (MOs) and semiconductor memories for distribution.

Memory mediums that can be used for the purpose of the present invention are not limited to those listed above and memory mediums of any type can also be used for the purpose of the present invention so long as they are computer-readable ones.

Additionally, the OS (operating system) operating on a computer according to the instructions of a program installed in the computer from a memory medium, data base management software and/or middleware such as network software may take part in each of the processes for realizing the above embodiment.

Still additionally, memory mediums that can be used for the purpose of the present invention are not limited to those independent from computers but include memory mediums adapted to download a program transmitted by LANs and/or the Internet and permanently or temporarily store it.

It is not necessary that a single memory medium is used with the above described embodiment. In other words, a plurality of memory mediums may be used with the above-described embodiment to execute any of the above described various processes. Such memory mediums may have any configuration.

For the purpose of the present invention, a computer executes various processes according to one or more than one programs stored in the memory medium or mediums as described above for the preferred embodiment. More specifically, the computer may be a stand alone computer or a system realized by connecting a plurality of computers by way of a network.

For the purpose of the present invention, computers include not only personal computers but also processors and microcomputers contained in information processing apparatus. In other words, computers generally refer to apparatus and appliances that can realize the functional features of the present invention by means of a computer program.

The present invention is by no means limited to the above described embodiment, which may be modified in various different ways without departing from the spirit and scope of the invention. Additionally, any of the components of the above described embodiment may be combined differently in various appropriate ways for the purpose of the present invention. For example, some of the components of the above described embodiment may be omitted. Alternatively, components of different embodiments may be combined appropriately in various different ways for the purpose of the present invention.

What is claimed is:

1. A data processing apparatus capable of updating and writing a plurality of distributed information items generated based on to-be-held secret information with respect to a storage device in which access is not limited, comprising:
a distributed information generation device configured to generate a plurality of distributed information items updated this time according to secret information to be held this time based on a threshold value secret distribution method,
a recording position selecting device configured to select recording positions of the distributed information items updated this time to leave behind distributed information items of a number less than a threshold value among the plurality of distributed information items updated last time or leave behind none of the above distributed information items with respect to a plurality of distributed information items updated and stored in the storage device, and
a distributed information writing device configured to write the distributed information items updated this time to the storage device based on the selected recording positions.

2. The data processing apparatus according to claim 1, wherein the distributed information generation device includes a preceding-information read device which reads distributed information items of a number less than the threshold value among the distributed information items updated last time, and a device which generates a plurality of distributed information items updated this time based on the threshold value secret distribution method to cause the read distributed information items used last time to be contained in the plurality of distributed information items updated this time.

3. The data processing apparatus according to claim 1, wherein the distributed information writing device includes a device configured to write (threshold value—1) distributed information items among the distributed information items updated this time to set the number of the distributed information items updated last time equal to the threshold value when the number of the distributed information items updated last time and stored in the storage device is larger than the threshold value, and a device configured to write one distributed information among the distributed information items updated this time over the distributed information items updated last time when the number of the distributed information items updated last time and stored in the storage device is equal to the threshold value.

4. A data processing apparatus capable of updating and writing a plurality of distributed information items generated based on to-be-held secret key information with respect to a storage device in which access is not limited, comprising:
a file input device configured to input a file by an operation of an operator,
a file key generation device configured to generate file key information according to the file,
a file encrypting device configured to encrypt the file by use of the file key information and write the thus obtained encrypted file to the storage device,
a key encrypting device configured to encrypt a key management file containing file addresses of the file key information and encrypted file and file addresses of different file key information and different encrypted file stored in the storage device by use of the secret key information and write the thus obtained encrypted key management file to the storage device,
a distributed information generation device configured to generate a plurality of distributed information items updated this time according to secret key information to be held this time based on a threshold value secret distribution method,
a recording position selecting device configured to select recording positions of the distributed information items updated this time to leave behind distributed information items of a number less than a threshold value among the plurality of distributed information items updated last time or leave behind none of the above distributed information items with respect to a plurality of distributed information items updated and stored in the storage device,
a distributed information writing device configured to write the distributed information items updated this time to the storage device based on the selected recording positions,
a device configured to read the distributed information items updated this time from the storage device,
a key restoring device configured to restore secret key information from the read distributed information items by use of the threshold value secret distribution method,
a device configured to decrypt the encrypted key management file in the storage device based on the restored secret key information to obtain a key management file, and
a device configured to decrypt a corresponding encrypted file in the storage device based on corresponding file key information in the key management file and a file address input from an exterior to obtain a file.

5. A program stored in a computer-readable recording medium used for a data processing apparatus capable of updating and writing a plurality of distributed information items generated based on to-be-held secret information with respect to a storage device in which access is not limited, comprising:
a first program code which causes the data processing apparatus to perform a process of generating a plurality of distributed information items updated this time according to secret information to be held this time based on a threshold value secret distribution method,
a second program code which causes the data processing apparatus to perform a process of selecting recording positions of the distributed information items updated this time to leave behind distributed information items of a number less than a threshold value among the plurality of distributed information items updated last time or leave behind none of the above distributed information items with respect to a plurality of distributed information items updated and stored in the storage device, and
a third program code which causes the data processing apparatus to perform a process of writing the distributed information items updated this time to the storage device based on the selected recording positions.

6. The program according to claim 5, wherein the first program code includes a fourth program code which causes the data processing apparatus to perform a process of reading distributed information items of a number less than the threshold value among the distributed information items updated last time, and a fifth program code which causes the data processing apparatus to perform a process of generating a plurality of distributed information items updated this time based on the threshold value secret distribution method to cause the read distributed information items used last time to be contained in the plurality of distributed information items updated this time.

7. The program according to claim 5, wherein the third program code includes a sixth program code which causes the data processing apparatus to perform a process of writing (threshold value—1) distributed information items among the distributed information items updated this time to the storage device to set the number of the distributed information items updated last time equal to the threshold value when the number of the distributed information items updated last time and stored in the storage device is larger than the threshold value, and a seventh program code which causes the data processing apparatus to perform a process of writing one distributed information among the distributed information items updated this time over the distributed information items updated last time when the number of the distributed information items updated last time and stored in the storage device is equal to the threshold value.

8. A program stored in a computer-readable recording medium used for a data processing apparatus capable of updating and writing a plurality of distributed information items generated based on to-be-held secret key information with respect to a storage device in which access is not limited, comprising:
a first program code which causes the data processing apparatus to perform a process of inputting a file by an operation of an operator,
a second program code which causes the data processing apparatus to perform a process of generating file key information according to the file,
a third program code which causes the data processing apparatus to perform a process of encrypting the file by use of the file key information and writing the thus obtained encrypted file to the storage device,
a fourth program code which causes the data processing apparatus to perform a process of encrypting a key management file containing file addresses of the file key information and encrypted file and file addresses of different file key information and different encrypted file stored in the storage device by use of the secret key information and writing the thus obtained encrypted key management file to the storage device,
a fifth program code which causes the data processing apparatus to perform a process of generating a plurality of distributed information items updated this time according to secret key information to be held this time based on a threshold value secret distribution method,
a sixth program code which causes the data processing apparatus to perform a process of selecting recording positions of the distributed information items updated this time to leave behind distributed information items of a number less than a threshold value among the plurality of distributed information items updated last time or leave behind none of the above distributed information items with respect to a plurality of distributed information items updated and stored in the storage device,
a seventh program code which causes the data processing apparatus to perform a process of writing the distributed information items updated this time to the storage device based on the selected recording positions,
an eighth program code which causes the data processing apparatus to perform a process of reading the distributed information items updated this time from the storage device,
a ninth program code which causes the data processing apparatus to perform a process of restoring secret key information from the read distributed information items based on the threshold value secret distribution method,
a tenth program code which causes the data processing apparatus to perform a process of decrypting the encrypted key management file in the storage device based on the restored secret key information to obtain a key management file, and
an eleventh program code which causes the data processing apparatus to perform a process of decrypting a corresponding encrypted file in the storage device based on corresponding file key information in the key management file and a file address input from an exterior to obtain a file.
